(19) United States
(12) Patent Application Publication
(10) Pub. No.: US 2024/0006890 A1
(43) Pub. Date: Jan. 4, 2024

(54) LOCAL VOLT/VAR CONTROLLERS WITH STABILITY GUARANTEES

(71) Applicants: Alliance for Sustainable Energy, LLC, Golden, CO (US); Regents of the University of Minnesota, Minneapolis, MN (US)

(72) Inventors: Guido CAVRARO, Littleton, CO (US); Manish Kumar SINGH, Minneapolis, MN (US)

(21) Appl. No.: 18/337,578

(22) Filed: Jun. 20, 2023

Related U.S. Application Data
(60) Provisional application No. 63/353,473, filed on Jun. 17, 2022.

(51) Int. Cl. H02J 3/38; H02J 3/16

(52) U.S. Cl. CPC H02J 3/381; H02J 3/16; H02J 2203/20; H02J 2203/10

(57) ABSTRACT

A device may calculate a reactive power setpoint associated with a distributed energy resource (DER) electrically coupled to a power distribution network, based on a local voltage value associated with the DER. The device may control a reactive power output of the DER in association with regulating voltage at the power distribution network, based on the reactive power setpoint.

### CROSS-REFERENCE TO RELATED APPLICATIONS

The present application claims the benefit of U.S. Provisional Application Ser. No. 63/353,473 filed Jun. 17, 2022. The entire disclosure of the provisional application listed is hereby incorporated herein by reference, in its entirety, for all that the disclosure teaches and for all purposes.

### GOVERNMENT LICENSE RIGHTS

This invention was made with government support under Contract No. DE-AC36-08GO28308 awarded by the Department of Energy. The government has certain rights in the invention.

### FIELD OF THE INVENTION

The present invention generally relates to power distribution networks, and more particularly, to voltage regulation in power distribution networks.

### BACKGROUND OF THE INVENTION

Some power distribution networks incorporate distributed energy resources (DERs) as a source of energy. In some cases, uncoordinated power injections or sudden changes in power generation by DERs could pose challenges to system stability and power quality of a power distribution network. Techniques facilitating the integration of DERs in a power distribution network while ensuring system stability and power quality are desired.

### SUMMARY

In some aspects, the techniques described herein relate to a device including: at least one processor; and at least one module operable by the at least one processor to: calculate a reactive power setpoint associated with a DER electrically coupled to a power distribution network, based at least in part on a local voltage value associated with the DER; and control a reactive power output of the DER in association with regulating voltage at the power distribution network, based at least in part on the reactive power setpoint.

In some aspects, the techniques described herein relate to a device, wherein: calculating the reactive power setpoint is based at least in part on a learned function associated with the DER, wherein the learned function includes a mapping of a set of candidate local voltages associated with the DER to a set of candidate reactive power setpoints associated with DER.

In some aspects, the at least one module operable by the at least one processor is to: provide the local voltage value associated with the DER to a machine learning network; and receive the reactive power setpoint associated with the DER in response to the machine learning network processing the local voltage value in association with a learned function.

In some aspects, the at least one module operable by the at least one processor is to train the machine learning network based at least in part on a set of reference local voltage values associated with the DER and a set of reference equilibrium points associated with the power distribution network, wherein training the machine learning network includes generating the learned function.

In some aspects, the at least one module operable by the at least one processor is to train the machine learning network based at least in part on: one or more target reactive power setpoints associated with the DER and the power distribution network; and one or more reactive power injections associated with the power distribution network, wherein the one or more reactive power injections are non-controllable by the device.

In some aspects, the at least one module operable by the at least one processor is to at least one of: iteratively calculate the reactive power setpoint associated with the DER based at least in part on an increment; and iteratively set the reactive power output of the DER in response to one or more iterative calculations of the reactive power setpoint.

In some aspects, calculating the reactive power setpoint is based at least in part on one or more cost functions arbitrarily selected from a set of cost functions associated with the power distribution network.

In some aspects, calculating the reactive power setpoint, controlling the reactive power output, or both is independent of at least one second DER electrically coupled to the power distribution network.

In some aspects, the device includes a reactive power controller device associated with the DER.

In some aspects, the techniques described herein relate to a method including: calculating a reactive power setpoint associated with a DER electrically coupled to a power distribution network, based at least in part on a local voltage value associated with the DER; and controlling a reactive power output of the DER in association with regulating voltage at the power distribution network, based at least in part on the reactive power setpoint.

In some aspects, the techniques described herein relate to a method, wherein: calculating the reactive power setpoint is based at least in part on a learned function associated with the DER, wherein the learned function includes a mapping of a set of candidate local voltages associated with the DER to a set of candidate reactive power setpoints associated with DER.

In some aspects, the method further includes: providing the local voltage value associated with the DER to a machine learning network; and receiving the reactive power setpoint associated with the DER in response to the machine learning network processing the local voltage value in association with a learned function.

In some aspects, the method further includes: iteratively calculating the reactive power setpoint associated with the DER based at least in part on an increment; and iteratively setting the reactive power output of the DER in response to one or more iterative calculations of the reactive power setpoint.

In some aspects, calculating the reactive power setpoint is based at least in part on one or more cost functions arbitrarily selected from a set of cost functions associated with the power distribution network.

In some aspects, calculating the reactive power setpoint, controlling the reactive power output, or both is independent of at least one second DER electrically coupled to the power distribution network.

In some aspects, the techniques described herein relate to a device associated with a DER electrically coupled to a power distribution network, the device including: sensing circuitry to sense a local voltage value associated with the DER; processing circuitry to calculate a reactive power setpoint associated with a distributed energy resource (DER) electrically coupled to the power distribution network, based at least in part on the local voltage value associated with the DER; and control circuitry to control a reactive power output of the DER in association with regulating voltage at the power distribution network, based at least in part on the reactive power setpoint.

In some aspects, the processing circuitry is to: calculate the reactive power setpoint based at least in part on a learned function associated with the DER, wherein the learned function includes a mapping of a set of candidate local voltages associated with the DER to a set of candidate reactive power setpoints associated with DER.

In some aspects, the device further includes one or more trained machine learning models, wherein: the processing circuitry is to provide the local voltage value associated with the DER to a machine learning network; and the machine learning network is to provide the reactive power setpoint associated with the DER in response to processing the local voltage value in association with a learned function.

In some aspects, the processing circuitry is to: iteratively calculate the reactive power setpoint associated with the DER based at least in part on an increment; and iteratively set the reactive power output of the DER in response to one or more iterative calculations of the reactive power setpoint.

In some aspects, the processing circuitry is to: calculate the reactive power setpoint based at least in part on one or more cost functions arbitrarily selected from a set of cost functions associated with the power distribution network.

### BRIEF DESCRIPTION OF THE DRAWINGS

FIG. 1 illustrates an example of system in accordance with aspects of the present disclosure.

FIG. 2 is a graphical plot illustrating the total demand and solar generation across the distribution network depicted in FIG. 1, in accordance with aspects of the present disclosure.

FIG. 3 is a graphical plot illustrating the learned equilibrium function of a DER, along with the exact optimal reactive power setpoints obtained by solving by (P 1), in accordance with aspects of the present disclosure.

FIG. 4 is a graphical plot illustrating the evolution of the reactive power injections of DERs when loads are fixed, in accordance with aspects of the present disclosure.

FIG. 5 is a graphical plot illustrating the minimum voltage deviations in accordance with aspects of the present disclosure.

FIG. 6 is a graphical plot illustrating the line power losses in accordance with aspects of the present disclosure.

FIG. 7 illustrates an example of a system that supports aspects of the present disclosure.

FIG. 8 illustrates an example of a process flow that supports aspects of the present disclosure.

### DETAILED DESCRIPTION

The present disclosure considers the problem of voltage regulation in distribution networks (also referred to herein as power distribution networks, power networks, distribution grids, or power grids). The techniques described herein aim to keep voltages within pre-assigned operating limits by commanding the reactive power output of distributed energy resources (DERs) deployed in the grid. In some example aspects described herein, the provided framework for developing local Volt/Var control may include two main steps. It is to be understood that the example implementations described herein are not limited to the two example steps described herein, and the example implementations may include one or more steps which may be performed before, after, or in combination with one or more of the two steps.

In the first step, exploiting historical data, and for each DER, the techniques described herein include learning a function representing target equilibrium points for the distribution network. In some aspects, the target equilibrium points approximate solutions of a power flow problem (e.g., an optimal power flow problem) associated with the distribution network. In the second step, the techniques described herein may include providing a control scheme for steering the network towards favorable configurations associated with the target equilibrium points and the optimal power flow problem. Herein, the techniques described herein may include deriving theoretical conditions to formally guarantee the stability of the developed control scheme, and example numerical simulations described herein illustrate the effectiveness of the proposed approach.

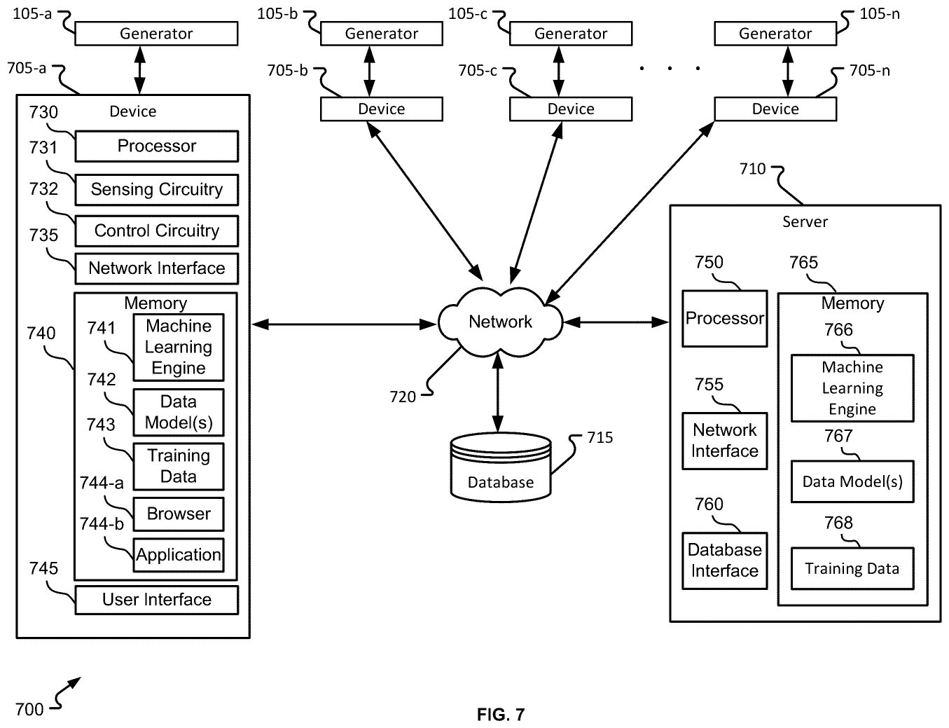

The deployment of a massive number of DERs in distribution networks (DNs) is dramatically changing the electric power grid. Primarily driven by sustainability and economic incentives, DERs present additional opportunities including voltage profile improvements and the line-loss reduction. At the same time, uncoordinated power injections or sudden generation changes by DERs could pose challenges to system stability and power quality. To facilitate the integration of DERs in power grids, aspects of the present disclosure include providing DERs with sensing and computation capabilities that support the DERs becoming smart agents. Aspects of the sensing and computation capabilities may be implemented at a device, examples of which are later described with reference to FIG. 7. Further, using the sensing and computation capabilities, DERs can exploit the flexibility of their power electronic interface to control the reactive power injection/withdrawal. Motivated by these observations, aspects of the present disclosure provide reactive power controllers (also referred to herein as Volt/Var controllers) to regulate voltages for distribution networks.

Other control methods developed for distribution networks in recent years fit in the categories of distributed or local control strategies. With respect to distributed control strategies, DERs may communicate and share information in a communication network. With respect to local control strategies, generators use only locally available information. Distributed algorithms steer the distribution network towards solutions of optimization problems called optimal power flow (OPF) problems in which the power generation cost, the line losses, or the deviations from the nominal voltage are optimized. Nevertheless, distributed strategies have usually precise and strict requirements on the communication network.

For instance, in some distributed strategies, each generator is required to share information with all its neighbors (e.g., other generators, other devices, etc.) in the power system. In local schemes, power injections are adjusted based on measurements taken at the point of connection of the power inverter to the grid. In some cases, the goal is to maintain voltages within threshold voltage thresholds (e.g., safe limits). Though simpler than distributed strategies, some local schemes have intrinsic performance limitations. For example, some local schemes may fail to regulate voltages even if the overall generation resources (e.g., power provided by generators coupled to the grid) satisfy power requirements associated with the grid.

To enhance the performance of local schemes and reduce the gap with distributed and/or optimal controllers, some efforts have devised customized control rules using data-driven and machine learning methods. In some cases, a data set for learning control functions can be created by solving OPF problems using historical consumption and generation data, e.g., smart meter data. Indeed, some learning techniques have been used to obtain fast (approximate) solutions to OPF problems. Deep neural networks (DNNs) have been employed to predict OPF solutions that are converted to a physically implementable schedule upon projection using a power flow solver.

Some related art technologies include training a graph neural network leveraging the connectivity of the power system to infer AC-OPF solutions. Other related art technologies include training a DNN to fit not only OPF minimizers, but also their sensitivities with respect to the problem inputs. Some other related art technologies include designing piecewise linear control functions given the number of break points.

Other related art technologies have considered an OPF problem whose objective function penalizes the voltage deviations from the nominal one and the control effort. Such related art technologies include deriving stable local controllers that steer the system toward an approximated solution. Continuous time local reactive power control schemes are designed as part of one related art technology to solve an OPF problem with voltage constraints. However, reactive power capacity limits, critical when dealing with small-size generators, are not imposed.

Aspects of the present disclosure provide a framework for designing a local Volt/Var scheme in which a goal of the local Volt/Var scheme is not only to regulate voltages but also to act as local surrogates of OPF solvers. According to example aspects of the present disclosure, the strategy includes two-stages. First, for each agent, the systems and techniques described herein support learning a function (referred to herein as equilibrium function) providing OPF solution surrogates from historical data. Precisely, such a function receives as input the local voltage and provides as an output an approximation of the optimal reactive power setpoint. Second, the systems and techniques described herein support devising a control algorithm whose equilibrium points (i) are asymptotically stable, and (ii) are exactly the OPF approximated solutions provided by the equilibrium function.

Aspects of the present disclosure supportive of the systems and techniques described herein utilize the following example notation: lower- (upper-) case boldface letters denote column vectors (matrices). Given a vector a, the n-th entry of vector a is denoted as aₙ. Sets are represented by calligraphic symbols. The symbol ^{T} stands for transposition, and inequalities are understood element-wise. The vector of all ones is denoted by 1; the corresponding dimension should be clear from the context. The operator |⋅| yields: the absolute value for real-valued arguments; the magnitude for complex-valued arguments; and the cardinality when the argument is a set. The set of complex numbers, of real numbers, and of nonnegative real numbers are denoted as [symbol] , [symbol] , and [symbol] _{≥0}, respectively. Operators [symbol] (⋅) and [symbol] (⋅) extract the real and imaginary parts of a complex-valued argument, respectively, and act entry-wise. Given a matrix A, an eigenvalue λ with its associated eigenvector ξ forms the eigenpar (λ, ξ). The norm of A is defined by ∥A∥=\sqrt{λₘₐₓ(A^{T}A)}, where λₘₐₓ(A^{T}A) is the largest eigenvalue of A^{T}A. This definition coincides with the 2-norm of a matrix. The graph of a function ϕ: [symbol] → [symbol] is the set of all points of the form (x, ϕ(x)), with x∈ [symbol] .

Consider a power distribution network with N+1 buses modeled by an undirected graph [symbol] =( [symbol] , ε), whose nodes [symbol] ={0, 1, . . . , N} are associated with the electrical buses and edges represent the electric lines. The techniques described herein include labeling the substation node as 0, and assuming that the substation node labeled as 0 behaves as an ideal voltage generator imposing the nominal voltage of 1 p.u. Define the following quantities:
uₙ∈ [symbol] is the voltage at bus n∈ [symbol] .
vₙ∈ [symbol] is the voltage magnitude at bus n∈ [symbol] .
iₙ∈ [symbol] is the current injected at bus n∈ [symbol] .
sₙ=pₙ+iqₙ∈ [symbol] is the nodal complex power at bus n∈ [symbol] , where pₙ, qₙ∈ [symbol] are the active and reactive powers. Powers will take positive (negative) values, i.e., pₙ, qₙ≥0 (pₙ, qₙ≤0), when they are injected into (absorbed from) the grid.
y_{(v,w)}∈ [symbol] is the admittance of line (v,w)∈ε.

Vectors u, i, s∈ [symbol] ⁿ collect the complex voltages, currents, and complex powers of buses 1, 2, . . . , n; and the vectors v, p, q∈ [symbol] ⁿ collect the voltage magnitudes, and their active and reactive power injections. Denote by zₑ and yₑ=zₑ⁻¹ the impedance and the admittance of line e=(m, n)∈ε. The network bus admittance matrix Y∈ [symbol] ^{(N+1)×(N+1)} is a symmetric matrix that can be expressed as Y=Y_{L}+diag(y_{T}), where

$${( {Y}_{L} )}_{m n} = \{ \begin{matrix}- {y}_{( m , n )} if ( m , n ) ∈ E , m \neq n , \\ {\sum }_{m \neq n} {y}_{( m , n )} if m = n ,\end{matrix} \qquad ( 1 )$$

and the vector y_{T} collects the shunt components of each line. The matrix Y_{L} is a complex Laplacian matrix, and hence satisfies Y_{L}1=0. We partition the bus admittance matrix separating the components associated with the substation and the ones associated with the other nodes, obtaining

$$Y = [ \begin{matrix}{y}_{0} & {y}_{0}^{T} \\ {y}_{0} & \tilde{Y}\end{matrix} ]$$

with y₀∈ [symbol] , y₀∈ [symbol] ^{N}, \tilde{Y}∈ [symbol] ^{N×N}. If the network is connected, \tilde{Y} is invertible. Let \tilde{Z}:=\tilde{Y}⁻¹, \tilde{R}:= [symbol] {\tilde{Z}}, and \tilde{X}:= [symbol] {\tilde{Z}}∈ [symbol] [symbol] ^{N×N}. The power flow equation can be written as

u=\tilde{Z}i+û, (2a)

u₀=1, (2b)

uₙι̅ₙ=pₙ+jqₙ,n≠0, (2c)

where ι̅ₙ denotes the complex conjugate of iₙ and û:=\tilde{Z}y₀. Equation (2a) represents the Kirchoff equations and provides the relation between voltages and currents. Finally, equation (2c) comes from the fact that all the nodes, except the substation, are modeled to be constant power buses. Voltage magnitudes are nonlinear functions of the nodal power injections; however, using a first-order Taylor expansion, the power flow equation can be linearize to obtain

v=\tilde{R}p+\tilde{X}q+|û|, (3)

and to express the power losses as a scalar quadratic function of the power injections

l=q^{T}\tilde{R}q+p^{T}\tilde{R}p. (4)

Assume a subsect [symbol] ⊆ [symbol] of buses host DERs, with | [symbol] |=C. The remaining nodes constitute the set [symbol] = [symbol] \ [symbol] . Every DER corresponds to a smart agent that measures its voltage magnitude and performs reactive power compensation. It is convenient to partition reactive powers and voltage magnitudes by grouping together the nodes belonging to the same set

q=[q_{C}^{T}q_{L}^{T}]^{T},v=[v_{C}^{T}v_{L}^{T}]^{T}.

Also, the matrices \tilde{R} and \tilde{X} can be decomposed according to the former partition, yielding

$$\tilde{R} = [ \begin{matrix}R & {R}_{L} \\ {R}_{L}^{T} & {R}_{L L}\end{matrix} ] , \tilde{X} = [ \begin{matrix}X & {X}_{L} \\ {X}_{L}^{T} & {X}_{L L}\end{matrix} ] . \qquad ( 5 )$$

with R and X being positive-definite matrices. Fixing the active and reactive loads along with the active solar generation, from equations (3) and (4), voltage magnitudes and power losses become functions exclusively of q_{C}:

$$v ( {q}_{C} ) = [ \begin{matrix}X \\ {X}_{L}^{T}\end{matrix} ] {q}_{C} + \hat{v} \qquad ( 6 a )$$

$$l ( {q}_{C} ) = {q}_{C}^{T} R {q}_{C} + {q}_{C}^{T} w + \hat{l} , \qquad ( 6 b )$$

where the following definitions are used

$$\hat{v} : = [ \begin{matrix}{X}_{L} \\ {X}_{L L}\end{matrix} ] {q}_{L} + \tilde{R} p + \vert \hat{u} \vert , \qquad ( 7 a )$$

$$w := 2 {R}_{L} {q}_{L} , \qquad ( 7 b )$$

$$\hat{l} : = {q}_{L}^{T} {R}_{L L} {q}_{L} + {p}^{T} \tilde{R} p . \qquad ( 7 c )$$

With the model set up, a two-stage approach is provided to optimally utilize the flexibility in DER reactive powers while ensuring the stable operation of the distribution network (DN). In the first stage, the techniques described herein include formulating a centralized OPF instance to determine optimal DER reactive-power setpoints given the non-controllable (re)active power injections across the distribution network. While the considered OPF formulation is convex, solving numerous instances of the considered OPF formulation for real-time operation may be computationally challenging. Further, the necessity for (re)active power information from across the network introduces communication challenges. Towards alleviating the aforementioned concerns of computational challenges and communication challenges, the systems and techniques described herein support training a fleet of neural networks (e.g., one per DER) to (approximately) predict the optimal setpoints using local nodal voltages as inputs (e.g., given merely local nodal voltages as inputs). For the second stage, the systems and techniques described herein provide a control scheme that supports steering the DER reactive-power injections to the setpoints obtained from the neural network outputs while formally guaranteeing stability.

An example OPF formulation for DER dispatch would solve for an optimal q_{C}*, given the tuple (p, q_{L}), such that the stipulated voltage limits and DER reactive-power capacity limits are satisfied and a certain network criterion is optimized. The systems and techniques described herein support considering OPF problems based on arbitrary cost functions. In some aspects, although arbitrary cost functions could be considered, here an OPF problem that minimizes line losses is considered. Such an OPF can be posed as

$${q}_{C}^{*} ( p , {q}_{L} ) := {arg min}_{{q}_{c}} l ( {q}_{C} ) \qquad ( P 1 )$$

$$s . t . ( 6 ) - ( 7 ) , and \qquad ( 8 a )$$

$${v}_{min} \leq v ( {q}_{C} ) \leq {v}_{max} , \qquad ( 8 b )$$

$${q}_{min} \leq {q}_{C} \leq {q}_{max} , \qquad ( 8 c )$$

Where vₘᵢₙ, vₘₐₓ∈ [symbol] ^{N} are target (e.g., desired) voltage lower and upper limits on all the network busses, and qₘᵢₙ, qₘₐₓ∈ [symbol] ^{C} are the minimum and maximum reactive power injections associated with the DERs. In the example, the set of the feasible reactive power injections for the DER at node n is denoted as [symbol] ₙ={qₙ:qₙ∈[q_{min,n},q_{max,n}]}. Problem (P1) is strictly convex and admits a unique minimizer. Moreover, the minimizer is a function of the uncontrolled variables p and q_{L}, which appear implicitly in the objective function and the constraint (8b) via (7).

In principle, solving (P1) given a tuple (p, q_{L}) is tractable, given the problem convexity. However, due to high penetration of renewable generation, some DNs are witnessing increased variability (e.g., in power) that requires solving numerous instances of the OPF problem of (P1) within a limited time-budget. Aiming at tackling the challenge, some neural network-based approaches have been put forth to predict approximates of q_{C}* with (p, q_{L}) being presented as the neural-network inputs. Once trained, the time required for neural network inference when presented with a new input is minimal. While such neural network-based approaches may alleviate the computational burden of solving OPFs, the need for the network-wide quantities (p, q_{L}) imposes a significant communication burden for implementation. To reduce the computational and communication complexities simultaneously, some approaches include deploying solutions based on local control rules, but performance of such approaches in terms of optimality is generally lacking. For DER reactive-power dispatch to achieve voltage regulation, such rules are often presented as piecewise linear functions of local voltages. Designing local control rules to harness efficient distribution network operation has recently garnered tremendous interest.

Example aspects of the disclosure provide a two-stage approach. In the first stage, termed learning stage, the systems and techniques described herein use historical data to learn functions that map voltages to (approximate) solutions of the OPF problem (P1). Specifically, for each agent n∈ [symbol] , the systems and techniques support learning a function ϕₙ of the local voltage vₙ as

ϕₙ: [symbol] → [symbol] ₙ,vₙ [symbol] ϕₙ(vₙ) (9)

with ϕₙ(vₙ) providing reactive power surrogates. The systems and techniques include the generators injecting reactive power setpoints q_{C} such that, for each n∈ [symbol] ,

qₙ=ϕₙ(vₙ), (10)

where the voltage vₙ in turn depends on the reactive power injection q_{C} as per equation (6a). Hence, the graph of the function ϕₙ, namely, points of the form (vₙ, ϕₙ(vₙ)), includes desirable network configurations which are surrogates of solutions of (P1). Accordingly, for example, the functions [symbol] described herein are termed equilibrium functions. In the second stage, termed control stage, the systems and techniques described herein provide local control rules which steer the network to configurations satisfying (10) for each n∈ [symbol] .

The outcome of the learning stage includes functions that map local voltage to (approximated) target reactive power setpoint. In an example, the target reactive power setpoint may be referred to as an optimal reactive power setpoint. In some aspects, the techniques described herein may include more than applying the reactive power setpoints provided by the learning function. For example, the techniques described herein include considering the case in which only a few power injections, i.e., the DERs, are controlled. Applying the OPF solution surrogates q_{C}^{#}=ϕ(v_{C}), computed using the voltages v_{C}, in general, could change the voltages to a new configuration v_{C}(q^{#})≠v_{C}. That is, (vₙ(q_{C}),qₙ^{#}) belongs to graph of ϕₙ, but (vₙ(q_{C}^{#}),qₙ^{#}) does not. Hence the new configuration is not an approximated power flow solution. The control scheme implemented in accordance with aspects of the present disclosure aims exactly at iteratively steering the systems (e.g., associated with a distribution network) toward configurations belonging to the graph of the equilibrium functions.

Example aspects of the present disclosure are described herein that support the approach to learn equilibrium functions for each agent in [symbol] that describe the solutions of (P1) as a function of the individual voltages. First, the labeled dataset required to accomplish the desired learning task is obtained as described. Given that (P1) takes (p, q_{L}) as input, the techniques described herein include first building a set {(p^{k}, q_{L}^{k})}ₖ₌₁^{K} of K load-generation scenarios. In an example, the techniques described herein include obtaining the aforementioned scenarios via random sampling from assumed probability distributions, historical data, or from forecasted conditions for a look-ahead period. Next, the techniques described herein include solving the OPF (P1) for the K scenarios to obtain the corresponding minimizers (v(q_{C}*),q_{C}*(p,q_{L})). The techniques include then separating entries for the minimizers for each n∈ [symbol] to obtain datasets of the form [symbol] ₙ={(v_{n,k}*,q_{n,k}*)}ₖ₌₁^{K}, where the parametric dependencies have been omitted for notational ease.

Next, the techniques include independently learning equilibrium functions, one per node in [symbol] , such that the elements of the respective sets [symbol] ₙ are close to the graphs of the learned functions; with proximity quantified in terms of the squared error. Specifically, using the mean squared error (MSE) metric, the learning task can be posed as

$$min \frac{1}{K} {Σ}_{k = 1}^{K} \vert {ϕ}_{n , k} ( {v}_{n , k}^{*} ) - {q}_{n , k}^{*} {\vert}^{2} . \qquad ( 11 )$$

In some additional aspects, the techniques include imposing the following conditions on each ϕₙ: each ϕₙ has to be C1) differentiable; C2) nonincreasing; and C3) with range in [symbol] ₙ. Examples of the motivation for the conditions C1, C2, and C3 will be clear later herein. Since neural networks are employed to construct the equilibrium functions, the systems and techniques described herein ensure that C1)-C3) are satisfied by choosing activation functions such as sigmoids, tanh, and softsign. In the following example, the techniques described herein include training the equilibrium functions using a single layer neural network and, as activation functions, we choose

$$σ ( x ) = \frac{{e}^{x} - {e}^{- x}}{{e}^{x} + {e}^{- x}} .$$

The next result gives a parameterization for a function satisfying C1)-C3) using a single hidden layer neural network.

Lemma 1. (Parameterization of neural network satisfying the target (e.g., desired) requirements): Consider a neural network NN(x): [symbol] with one hidden layer of H neurons, with output defined as

NN(x)=Σₕ₌₁^{H}wₕσ(x+bₕ) (12)

where σ(⋅) is the tanh activation function and (wₕ, bₕ) denote the weight and bias associated with the h-th neuron. If wₕ≤0, for all h, then NN is continuous, differentiable, and non-increasing. Further, if Σₕ₌₁^{H}|wₕ|≤W, then NN(x)∈[−W, W], for all x∈ [symbol] .
Proof. Continuity and differentiability of NN trivially stems from that of σ. To establish the non-increasing property, taking the derivative obtains

$$\frac{d N N ( x )}{d x} = {Σ}_{h = 1}^{H} {w}_{h} \frac{d σ ( x + {b}_{h} )}{d x} \leq 0 ,$$

using the fact that the derivative of tanh function is always positive and that wₕ≤0, for all h. Owing to the above non-increasing property, the supremum (infimum) of NN is attained for the limit x→−∞(x→∞). Substituting

$${lim}_{x \to - ∞} σ ( x ) = - 1$$

in (12) provides

$${lim}_{x \to - ∞} N N ( x ) = {Σ}_{h = 1}^{H} \vert {w}_{h} \vert \leq W ,$$

where wₕ≤0 is used. Similarly evaluating for the limiting case x→∞, one obtains NN(x)∈[−W, W], thus completing the proof.

Lemma 1 means that the techniques described herein may support finding the desired equilibrium functions [symbol] by training the parameters of neural networks defined by equation (12). The requirement that the range of ϕₙ belongs to [symbol] ₙ is satisfied by selecting W=min{|q_{min,n}|, |q_{max,n}|}.

Next, an example local control scheme that aims to steer the system to configurations satisfying equations (10) and (6a) in accordance with aspects of the present disclosure is provided and analyzed. For each n∈ [symbol] , consider the following reactive power update rule

qₙ(t+1)=qₙ(t)+ϵ(ϕₙ(vₙ(t))−q₍ₜ₎), (13)

where vₙ(t) is determined by (6a), and ϵ is a suitable positive number with 0≤ϵ≤1. In an example, if algorithm (13) is initialized at qₙ(0)∈ [symbol] ₙ, then qₙ(t)∈ [symbol] for all t=1, 2, . . . ; indeed, the new reactive power setpoint is a convex combination of two numbers in [symbol] ₙ. The following result characterizes the convergence properties of equation (13).

Proposition 1. (Asymptotic stability of equilibrium points): Let the functions ϕₙ's meet conditions C1)-C3), and define

$$M = {max}_{n ∈ 𝒞} \{ {max}_{v ∈ ℝ} \vert \frac{d {ϕ}_{n}}{d v} \vert \} .$$

If the stepsize parameter ϵ>0 satisfies

$$ϵ \leq min \{ 1 , \frac{2}{( 1 + ‖ X ‖ M )} \} , \qquad ( 14 )$$

then the equilibria of the control rule (13) are asymptotically stable. Moreover, if q^{#} is an equilibrium point and v^{#}=v(q^{#}) is its associated voltage, then (vₙ^{#},qₙ^{#}) belongs to the graph of ϕₙ for every n∈ [symbol] .
Proof. To prove Proposition 1, it is convenient to express (13) in vectorial form as

q_{C}(t+1)=(1−ϵ)q_{C}(t)+ϵϕ(v_{C}(q(t)))=f(q_{C}(t)), (15)

where ϕ: [symbol] ^{C}→[qₘᵢₙ, qₘₐₓ] collects all the ϕₙ's, and f is the operator

f:[qₘᵢₙ,qₘₐₓ]→[qₘᵢₙ,qₘₐₓ]

q_{C} [symbol] (1−ϵ)q_{C}+ϵϕ_{C}(v(q)).

Using the chain rule and equation (6a), the Jacobian of f can be expressed as

J_{f}=(1−ϵ)I+J_{ϕ}X, (16)

where J_{ϕ} is the Jacobian of ϕ and can be explicitly written as

$${J}_{ϕ} = diag ( \{ \frac{d {ϕ}_{n} ( {v}_{n} )}{d {v}_{n}} \} ) .$$

J_{ϕ} is a diagonal matrix with nonpositive entries, because of property (i). Hence, equation (16) can be rewritten as

J_{f}=(1−ϵ)I−|J_{ϕ}|X. (17)

Let (λᵢ, ξᵢ) be an eigenpair for |J_{ϕ}|X. Trivially, (1−ϵ−ϵλᵢ, ξᵢ) is an eigenpair for J_{ϕ}. Hence, for the asymptotic stability of the equilibrium points of (13), the techniques described herein include ensuring that

|1−ϵ−ϵλᵢ|<1

for any eigenvalue λᵢ of |J_{ϕ}|X. The former can be split into two inequalities. The first yields λᵢ>−1, which is always true since |J_{ϕ}|X is positive semidefinite. The second instead reads ϵ(1+λᵢ)<2 and, using Lemma 2 (defined below), always holds if ϵ(1+∥X∥M)<2 or, equivalently if

$$ϵ < \frac{2}{( 1 + ‖ X ‖ M )}$$

Further, recall that the algorithm is defined for 0<ϵ<1. Equation (14) then follows. Finally, if q^{#} is an equilibrium of (13), by definition from equation (15) we have

q^{#}=(1−ϵ)q^{#}+ϵϕ(v(q^{#}))

and thus

q^{#}=ϕ(v(q^{#}))

And (vₙ^{#}, qₙ^{#}) belongs to the graph of ϕₙ for every n∈ [symbol] .

Lemma 2. The matrix |J_{ϕ}|X is positive semidefinite. Moreover, if λₘₐₓ is its maximum eigenvalue, it holds

λₘₐₓ≤∥X∥M. (20)

Proof. First, we show that X is a positive definite matrix. Let (λᵢ, ξᵢ) be an eigenpair for |J_{ϕ}|X. Then,

$$( {λ}_{i} , {X}^{\frac{1}{2}} {ξ}_{i} )$$

is an eigenpair for the symmetric positive semidefinite matrix

$${X}^{\frac{1}{2}} \vert {J}_{ϕ} \vert X .$$

### Indeed

$${X}^{\frac{1}{2}} \vert {J}_{ϕ} \vert {X}^{\frac{1}{2}} {X}^{\frac{1}{2}} {ξ}_{i} = {X}^{\frac{1}{2}} \vert {J}_{ϕ} \vert X {ξ}_{i} = {λ}_{i} {X}^{\frac{1}{2}} {ξ}_{i}$$

Hence, |J_{ϕ}|X is a positive semidefinite matrix, too. Moreover, using the triangle inequality and because J_{ϕ} is a diagonal matrix, we have that

$${λ}_{max} = ‖ {X}^{\frac{1}{2}} \vert {J}_{ϕ} \vert {X}^{\frac{1}{2}} ‖ \leq ‖ X ‖ ‖ ( {J}_{ϕ} ) ‖ \leq ‖ X ‖ {max}_{n ∈ 𝒞} \{ {max}_{v ∈ ℝ} \{ \frac{d {ϕ}_{n} ( v )}{d v} \} \} = ‖ X ‖ M .$$

Regarding the reasons for the requirements C1)-C3) on the learned equilibrium functions [symbol] , constraining the range of each ϕₙ to [symbol] ₙ ensures that the reactive power setpoints are always feasible and avoids the use of projections in (13). The continuity, the differentiability, and the monotonicity assumptions are instead used in the proof of Proposition 1. That is, imposing the requirements C1)-C3) on the learning of the equilibrium functions may guarantee the stability of the closed-loop system at the cost of, for example, potentially increasing the optimality gap.

With regard to non-incremental vs. incremental control rules, some approaches may update the reactive power using the rule

qₙ(t+1)=ϕₙ(vₙ(t)), (18)

where vₙ(t) is determined by (6a). Algorithms such as (18) may be referred to as non-incremental, because the new setpoints are determined based on the local voltage without explicitly exploiting a memory of past setpoints. In some cases, such approaches (e.g., using (18)) can thus result in large variations in reactive-power setpoints across timesteps. In contrast, some example algorithms (e.g., algorithm (13)) supported by aspects of the present disclosure may be referred to as incremental because the algorithms compute small (as determined by E) adjustments to the current setpoints. The example systems and techniques described herein include updating the reactive powers using non-incremental algorithms.

It is trivial to see that equilibrium points of equation (18) belongs to the graph of the equilibrium function, too. The main issue is ensuring the convergence of equation (18). However, some approaches provide conditions that guarantee the stability of non-incremental algorithms, usually expressed as bounds on the voltage function slope. Actually, one can show that equation (18) converges if

$$M \leq \frac{1}{‖ X ‖} \qquad ( 19 )$$

To use equation (18), one would then need to additionally enforce equation (19) in the learning process described above. The resulting equilibrium function would then provide approximations of the OPF solutions that are worsened because of the additional restriction. By contrast, the incremental approach in equation (13) as supported by aspects of the present disclosure can handle arbitrary finite maximum slopes M by choosing a suitable stepsize E that satisfies the condition (14).

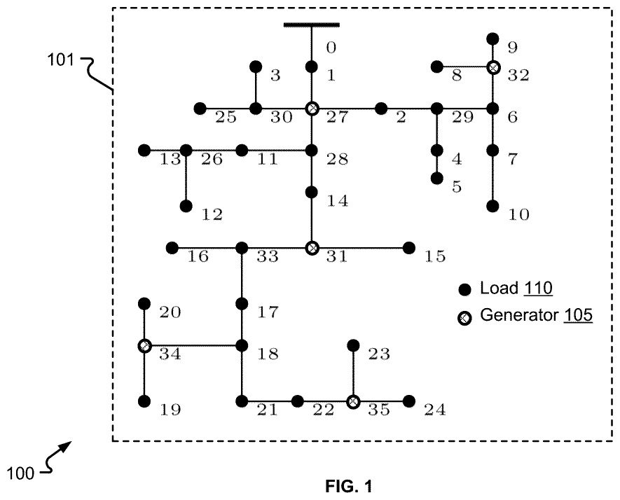

FIG. 1 illustrates an example of system 100 in accordance with aspects of the present disclosure. The system 100 may include a distribution network 101. The distribution network 101 also be referred to herein as a power distribution network, a distribution grid, or a power distribution grid. The system 100 may include generators 105 and loads 110 electrically coupled to the distribution network 101.

In the example of FIG. 1, the generators 105 may be DERs associated with one or more technologies supportive of providing power to the distribution network 101. Non-limiting examples of the generators 105 include renewable energy sources (e.g., solar photovoltaic (PV) panels, wind turbines, hydropower systems, biomass generators, etc. capable of generating electricity from naturally replenished resources), energy storage systems (e.g., batteries, flywheels, fuel cells, and other appropriate energy storage technologies capable of storing and supplying excess energy generated by renewable energy sources), combined heat and power (CHP) systems (e.g., a combustion turbine (reciprocating engine) with heat recovery unit, a steam boiler with steam turbine, etc.), electric vehicles (EVs) capable of bidirectional power flow between batteries of the EVs and the distribution network 101, and demand response technologies (e.g., demand response applications and devices that enable users or customers to adjust electricity usage based on grid conditions or price signals).

Each generator 105 may include or be coupled (e.g., via a wired connection, a wireless connection, etc.) to a device capable of controlling one or more functions associated with the generators 105. Examples of the device are later described with reference to a device 705 at FIG. 7. Examples of the distribution network 101 include IEEE bus feeders.

In an example, using the techniques of the present disclosure, a case study was conducted on an IEEE 37-bus feeder upon removing regulators, incorporating five generators 105 (e.g., solar generators), and converting the IEEE 37-bus feeder to a corresponding single-phase equivalent. FIG. 1 is a conceptual diagram illustrating the feeder used in the case study. In the examples described herein, the five generators 105 are DERs to be controlled by the systems and techniques described herein, and aspects of the present disclosure include performing simulations including the five generators 105 in association with computing the exact optimal solution of (P1) and the solution of the power flow equation described herein.

To set up the simulation, the Matlab-based OPF solver Matpower (discussed in R. D. Zimmerman, C. E. Murillo-Sanchez, and R. J. Thomas, “MATPOWER: steady-state operations, planning and analysis tools for power systems research and education,” IEEE Trans. Power Syst., vol. 26, no. 1, pp. 12-19, February 2011., the relevant portions of which are incorporated herein by reference) was used to compute both the exact optimal solution of (P1) and the solution of the power flow equation. The neural networks were implemented using TensorFlow 2.7.0, and the training process was conducted in Google Colab with a single TPU with 32 GB memory. The number of episodes and the number of neurons H were 1000 and 200, respectively. The neural networks were trained with the learning rate set to 0.01 using the Adam optimizer (discussed in D. P. Kingma and J. Ba, “Adam: A method for stochastic optimization,” in International Conference for Learning Representations, San Diego, CA, May 2015., the relevant portions of which are incorporated herein by reference).

The feeder has 25 buses with non-zero load (e.g., loads 110). Evaluating the feeder included extracting minute-based load and solar generation data for Jun. 1, 2018, from the Pecan Street dataset ((2018) Pecan Street Inc. Dataport. [Online]. Available: https://dataport.cloud/), and the first 75 non-zero load buses from the dataset are aggregated every 3 loads and normalized to obtain 25 load profiles. Similarly, 5 solar generation profiles were obtained for the active power of the generators 105 (e.g., DERs). The normalized load profiles for the 24-hour period are scaled so that 97% of the total load duration curve coincides with the total nominal load. This scaling results in a peak aggregate load being 1.1 times the total nominal load. The evaluation included synthesizing reactive loads by scaling active demand to match the power factors of the IEEE 37-bus feeder. The five generators 105 (e.g., DERs) have different generation capabilities, precisely, qₘₐₓ=[0.4020 0.4020 0.4020 0.0500 0.0500]^{T} and qₘᵢₙ=−gₘₐₓ. Voltage limits are set to vₘₐₓ=1.03 p.u. and vₘₐₓ=0.97 p.u.

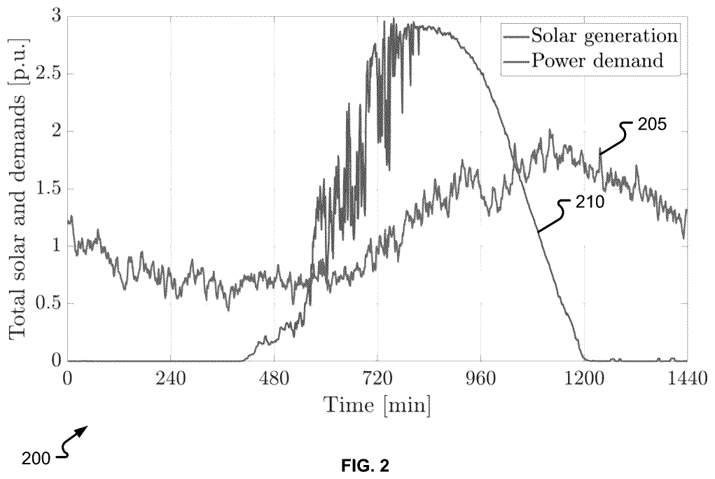

FIG. 2 is a graphical plot 200 illustrating the total power demand 205 and solar generation 210 across the distribution network 101 (feeder) depicted in FIG. 1. That is, FIG. 2 shows minute-based data for the total (feeder-wise) solar power generation and active power demand.

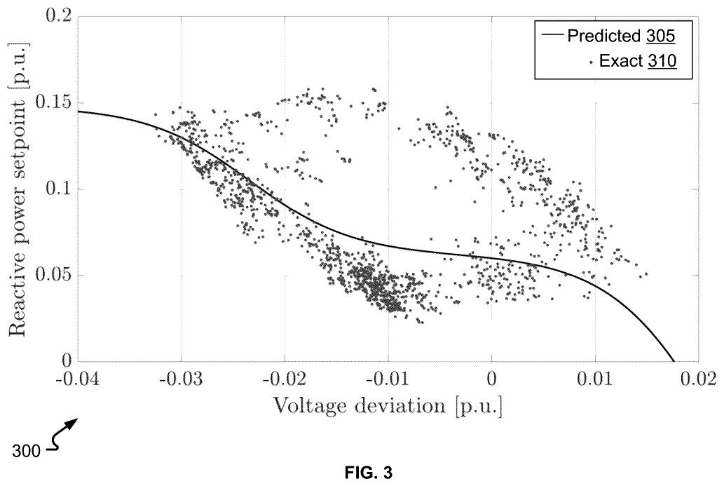

FIG. 3 is a graphical plot 300 illustrating the learned equilibrium function 305 of a generator 105 (e.g., a DER (also referred to herein as DER 32), etc.), along with the exact optimal reactive power setpoints 310 obtained by solving by (P1). In some aspects, the learned equilibrium function 305 supports providing a ‘predicted’ reactive power setpoint with respect to voltage deviation.

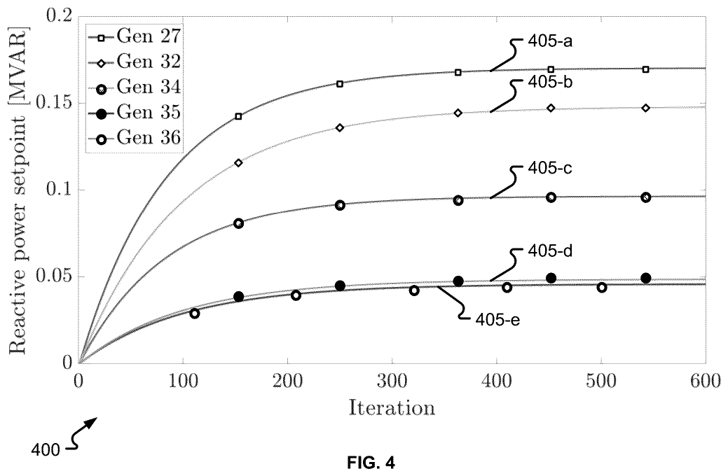

As part of the simulation, the stability properties of the local control algorithm (13) stated in Proposition 1 are first verified. FIG. 4 is a graphical plot 400 illustrating the evolution of the reactive power injections of the generators 105 (e.g., DERs, etc.) when loads are fixed. More specifically, FIG. 4 depicts the convergence property of the local control schemes (illustrated as power trajectories 405-a through 405-e, based on using the power data of the 1095-th minute and considering 600 iterations of performing control algorithm (13) with ϵ=0.01. As can be seen in the example of FIG. 4, the power trajectories 405-a through 405-e converge to their respective final values.

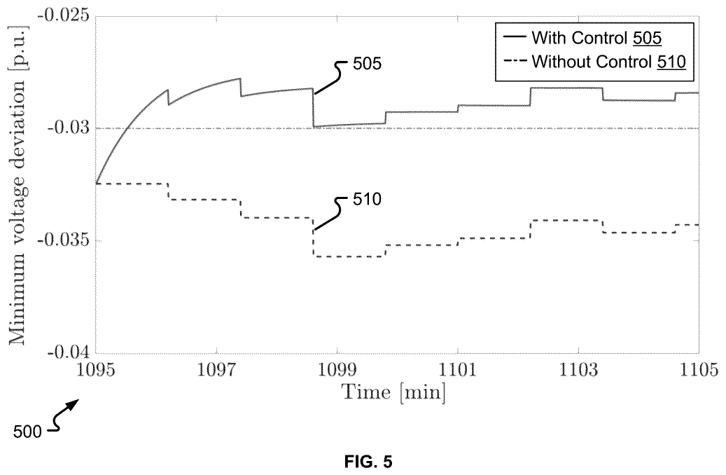

Next, example results illustrated at graphical plot 500 of FIG. 5 were obtained based on running the control algorithm (13) in a scenario in which loads are time-varying. Specifically, the loads were obtained by randomly perturbing the consumption data used to learn the equilibrium functions. This can be interpreted as having the data from the dataset prescribing a day-ahead forecast, whereas their random perturbation act as the true realization of the load. The loads are minute-based, and 120 iterations of implementing control algorithm (13) per minute were considered. FIG. 5 provides a comparison of the performance 505 of the system 100 (e.g., distribution network 101) when the agents (e.g., associated with respective generators 105) perform algorithm (13) and the performance 510 of the system 100 where control actions are not taken.

FIG. 5 is a graphical plot 500 illustrating the minimum voltage deviations. That is, FIG. 5 shows v−1. More specifically, FIG. 5 provides a comparison of the minimum voltage deviations associated with the proposed approaches and the uncontrolled case during time period [start time=1095 minutes; stop time=1105 minutes] with 120 iterations of implementing control algorithm (13) per minute and ϵ=0.01.

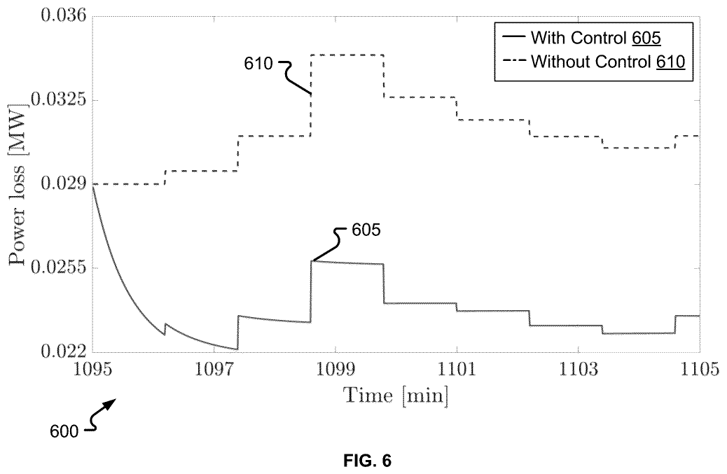

FIG. 6 is a graphical plot 600 illustrating the line power losses. More specifically, FIG. 6 depicts a comparison of the power loss 605 associated with the proposed approaches (e.g., with control) and the power loss 610 associated with the uncontrolled case during time period [start time=1095 minutes; stop time=1105 minutes] with 120 iterations of implementing control algorithm (13) per minute and ϵ=0.01. In contrast to the uncontrolled case, the techniques described herein bring the voltages back to the desired voltage region, and reduce line losses such that line losses are less than a threshold value (e.g., the techniques described herein significantly reduce line losses).

The systems and techniques of the present disclosure provide a two-stage approach to local Volt/Var control schemes capable of steering a power distribution network towards desirable equilibria. In the first stage, the techniques described herein include learning the equilibrium function for each DER bus that, given the local voltage associated with each DER bus, provides as an output a reactive power setpoint. Points in the graph of the equilibrium function represent approximations of solutions of an OPF problem. The techniques described herein employ a neural network representation that, by design, has the resulting equilibrium function be differentiable, non-increasing (but without constraints on the slope), and bounded. In the second stage, the techniques described herein include using an incremental control algorithm whose equilibria belong to the graph of the equilibrium function. The properties of the learned equilibrium maps play a key role in showing that the equilibria are asymptotically stable.

According to example aspects of the present disclosure, the systems and techniques described herein support asynchronous methods for controlling and monitoring of distribution grids (DGs) where a relatively large quantity of DERs and intelligent devices are deployed. For example, some techniques in the field of distributed control and estimation of active distribution grids are unable to be effectively implemented in large-scale distribution networks (e.g., large-scale distribution grids) because the techniques assume that agents (e.g., associated with DERs of the distribution grids) act in a synchronized fashion, even if the agents have different computation, communication, and actuation rates. However, perfect synchronization among the agents (and respective DERs) in large-scale distribution networks with a variety of sensors and actuators is impracticable.

The systems and techniques described herein support asynchronous control, optimization, and estimation schemes that are grounded on solid analytical foundations. The systems and techniques described herein may enable large-scale power systems to complete their transformation path and achieve the full integration of DERs and intelligent agents.

Example aspects of the present disclosure include a state estimator for systems with heterogeneous sensors, event-triggered control algorithms, and control algorithms for systems with local controllers.

In some aspects, the systems and techniques described herein address the problem of state estimation in a distribution grid in the case where the number of measurements available can be smaller than the number of states. For example, the number of measurements available may be smaller than the number of states because of asynchronicity among sensors associated with the distribution grid. The asynchronicity among sensors (e.g., lack of synchronization among sensors) is inherited by the fact that heterogeneous sensors (e.g., smart meters and PMUs) are deployed in distribution grids.

In an example, two independent scenarios of state estimation and tracking have been considered (with either voltages or currents as states) in association with developing the techniques described herein. With the two sets of data corresponding to the independent scenarios, estimation was investigated under (a) full data, assuming all measurements are available and (b) limited data, where an online algorithmic approach is adopted to estimate the possible time varying states by processing measurements as and when available. The example algorithms supported by aspects of the present disclosure, inspired by the classical Stochastic Gradient Descent (SGD) approach, include updating the states based on the previous estimate and the newly available measurements.

The systems and techniques described herein provide decentralized resource-aware coordination schemes for solving network optimization problems defined by objective functions which combine locally evaluable costs with network-wide coupling components. For example, the systems and techniques support implementations at a distribution network in which a group of supervised agents perform one or more operations associated with solving an optimization problem under coordination requirements associated with the supervised agents. In some aspects, the techniques described herein support implementations in which the coordination requirements among supervised agents are less restrictive (e.g., relatively mild) compared to coordination requirements associated with other distribution network implementations.

In an example, a distribution grid (e.g., distribution network 101) may be managed by a Distribution System Operator (DSO) (also referred to herein as a network supervisor). The DSO may be implemented, for example, by a computing device associated with the distribution grid. Intelligent agents (e.g., DERs, or computing devices associated with the DERs) can optimize the overall network performance using information parsimoniously sent by the DSO. In an example, each agent has information on local cost associated with the agent, and each agent coordinates with the DSO for information about the coupling term of the cost. The proposed approaches are feedback-based and asynchronous by design, guarantees anytime feasibility, and ensure the asymptotic convergence of the network state to the desired optimizer.

Aspects of the present disclosure include a data-driven framework developed for synthesizing local Volt/Var control strategies for DERs in power distribution networks. In an example, aiming at improving distribution network operation efficacy as quantified by a generic optimal reactive power flow problem, the techniques described herein include a two-step approach.

The first step involves learning the manifold of optimal operating points determined by an optimal reactive power flow (ORPF) instance. In an example, abiding by the goal of synthesizing local Volt/Var controllers, the techniques described herein include partitioning the learning task to learning local projections (e.g., per DER) of the optimal manifold with voltage input and reactive power output. In an example, the learned surrogates characterize efficient operating points associated with the distribution network.

Since the learned surrogates characterize efficient distribution network operating points, a second step includes a developed control scheme that steers the distribution network to the operating points. The techniques described herein include identifying conditions on the surrogates and the control parameters to ensure that the locally acting controllers collectively converge in a global asymptotic sense, for example, to an operating point agreeing with the local surrogates. The techniques described herein include using neural networks to model the local surrogates and enforce the identified conditions in the training phase.

The example implementations of the present disclosure may provide technical solutions to one or more of the problems of (1) managing distribution networks hosting heterogeneous devices, (2) performing state estimation, power regulation, and voltage control for a distribution network having sensors and actuators with different sampling, computation, or actuation rates, (3) regulating voltages at a distribution network even if the overall generation resources (e.g., power provided by generators coupled to the distribution network) satisfy power requirements associated with the distribution network, and (4) enhancing the performance of local schemes and reducing the gap with distributed and/or optimal controllers. For example, the asynchronous methods for control and estimation described herein may be beneficial in managing distribution networks hosting heterogeneous devices. The example framework described herein may enable system operators to perform state estimation, power regulation, and voltage control in the realistic scenario of sensors and actuators with different sampling, computation, or actuation rates.

FIG. 7 illustrates an example of a system 700 that supports voltage regulation in distribution networks in accordance with aspects of the present disclosure. The system 700 may implement aspects of system 100 described with reference to FIG. 1.

The system 700 may be capable of executing and controlling processes described herein associated with voltage regulation in a distribution network (e.g., distribution network 101 described with reference to FIG. 1). The system 700 may include devices 705 (e.g., device 705-a through device 705-n, where n is an integer value) electrically connected to generators 105 (as described with reference to FIG. 1). The generators 105 may be electrically coupled to and provide power to the distribution network. In some aspects, a device 705 (e.g., device 705-a) may be separate from a corresponding generator 105 (e.g., generator 105-a). In some other aspects, a device 705 (e.g., device 705-a) may be integrated with a corresponding generator 105 (e.g., generator 105-a) as a single device.

The device 705 may support data processing, sensing operations, control operations, and communication in accordance with aspects of the present disclosure. The device 705 may be a computing device. In some aspects, the device 705 may be a wireless communication device. Non-limiting examples of the device 705 may include, for example, personal computing devices or mobile computing devices (e.g., laptop computers, mobile phones, smart phones, smart devices, wearable devices, tablets, etc.). In some examples, the device 705 may be operable by or carried by a human user. In some aspects, the device 705 may perform one or more operations autonomously or in combination with an input by the user, the device 705, and/or the server 710.

The system 700 may include a server 710, a database 715, and a communication network 720. The server 710 may be, for example, a cloud-based server. In some aspects, the server 710 may be a local server connected to the same network (e.g., LAN, WAN, etc.) associated with the device 705. The database 715 may be, for example, a cloud-based database. In some aspects, the database 715 may be a local database connected to the same network (e.g., LAN, WAN, etc.) associated with the device 705 and/or the server 710. The database 715 may be supportive of data analytics, machine learning, and AI processing.

The communication network 720 may facilitate machine-to-machine communications between any of the device 705 (or multiple devices 705), the server 710, or one or more databases (e.g., database 715). The communication network 720 may include any type of known communication medium or collection of communication media and may use any type of protocols to transport messages between endpoints. The communication network 720 may include wired communications technologies, wireless communications technologies, or any combination thereof.

The Internet is an example of the communication network 720 that constitutes an Internet Protocol (IP) network consisting of multiple computers, computing networks, and other communication devices located in multiple locations, and components in the communication network 720 (e.g., computers, computing networks, communication devices) may be connected through one or more telephone systems and other means. Other examples of the communication network 720 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 720 may include of any combination of networks or network types. In some aspects, the communication network 720 may include any combination of communication mediums such as coaxial cable, copper cable/wire, fiber-optic cable, or antennas for communicating data (e.g., transmitting/receiving data).

In some cases, each generator 105 may operate individually and be coupled to a respective device 705, or two or more generators 105 may operate in the same group and be electrically coupled to device 705 common to the two or more generators 105.

In some cases, the server 710 or another device 705 (e.g., a device 705 not associated with a generator 105) may implement aspects described herein with reference to controlling one or more operations associated with a distribution network 101. In some examples, the server 710 or another device 705 (e.g., a device 705 not associated with a generator 105) may implement aspects of a Distribution System Operator (DSO) (network supervisor) described herein.

In various aspects, settings, configurations, and operations of the any of the generators 105, the devices 705, the server 710, database 715, and the communication network 720 may be configured and modified by any user and/or administrator of the system 700.

Aspects of the devices 705 and the server 710 are further described herein. A device 705 (e.g., device 705-a) may include a processor 730, sensing circuitry 731, control circuitry 732, a network interface 735, a memory 740, and a user interface 745. In some examples, components of the device 705 (e.g., processor 730, network interface 735, memory 740, user interface 745) may communicate over a system bus (e.g., control busses, address busses, data busses) included in the device 705. In some cases, the device 705 may be referred to as a computing resource.

The sensing circuitry 731 may include circuitry capable of monitoring or measuring the performance associated with a generator 105 (e.g., generator 105-a) electrically coupled to the device 705. For example, the sensing circuitry 731 may monitor the output power provided by the generator 105 to distribution network 101 and transmit data including the value of the output power to another device (e.g., another 705, server 710, database 715, etc.). In an example, the sensing circuitry 731 may be capable of sensing a local voltage value associated with the a generator 105 (e.g., a DER).

The processor 730 may include processing circuitry capable of calculating a reactive power setpoint associated with the generator 105, based on the local voltage value associated with the generator 105.

The control circuitry 732 may be capable of controlling a reactive power output of the generator 105 in association with regulating voltage at the distribution network 101, based on the reactive power setpoint.

In some cases, the device 705 may transmit or receive packets to one or more other devices (e.g., a generator 105, another device 705, the server 710, the database 715) via the communication network 720, using the network interface 735. The network interface 735 may include, for example, any combination of network interface cards (NICs), network ports, associated drivers, or the like. Communications between components (e.g., processor 730, memory 740) of the device 705 and one or more other devices (e.g., a generator 105, another device 705, the database 715) may, for example, flow through the network interface 735.

The processor 730 may correspond to one or many computer processing devices. For example, the processor 730 may include a silicon chip, such as a FPGA, an ASIC, any other type of IC chip, a collection of IC chips, or the like. In some aspects, the processors may include a microprocessor, CPU, a GPU, or plurality of microprocessors configured to execute the instructions sets stored in a corresponding memory (e.g., memory 740 of the device 705). For example, upon executing the instruction sets stored in memory 740, the processor 730 may enable or perform one or more functions of the device 705.

The memory 740 may include one or multiple computer memory devices. The memory 740 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 740, in some examples, may correspond to a computer-readable storage media. In some aspects, the memory 740 may be internal or external to the device 705.

The processor 730 may utilize data stored in the memory 740 as a neural network (also referred to herein as a machine learning network). The neural network may include a machine learning architecture. In some aspects, the neural network may be or include an artificial neural network (ANN). In some other aspects, the neural network may be or include any machine learning network such as, for example, a deep learning network, a convolutional neural network, or the like. Some elements stored in memory 740 may be described as or referred to as instructions or instruction sets, and some functions of the device 705 may be implemented using machine learning techniques.

The memory 740 may be configured to store instruction sets, neural networks, and other data structures (e.g., depicted herein) in addition to temporarily storing data for the processor 730 to execute various types of routines or functions. For example, the memory 740 may be configured to store program instructions (instruction sets) that are executable by the processor 730 and provide functionality of machine learning engine 741 described herein. The memory 740 may also be configured to store data or information that is useable or capable of being called by the instructions stored in memory 740. One example of data that may be stored in memory 740 for use by components thereof is a data model(s) 742 (e.g., a neural network model (also referred to herein as a machine learning model) or other model described herein) and/or training data 743 (also referred to herein as a training data and feedback).

The machine learning engine 741 may include a single or multiple engines. The device 705 (e.g., the machine learning engine 741) may utilize one or more data models 742 for recognizing and processing information obtained from one or more generators 105, other devices 705, the server 710, and the database 715. In some aspects, the device 705 (e.g., the machine learning engine 741) may update one or more data models 742 based on learned information included in the training data 743. In some aspects, the machine learning engine 741 and the data models 742 may support forward learning based on the training data 743. The machine learning engine 741 may have access to and use one or more data models 742.

The data model(s) 742 may be built and updated by the machine learning engine 741 based on the training data 743. The data model(s) 742 may be provided in any number of formats or forms. Non-limiting examples of the data model(s) 742 include Decision Trees, Support Vector Machines (SVMs), Nearest Neighbor, and/or Bayesian classifiers. In some aspects, the data model(s) 742 may include a predictive model such as an autoregressive model. Other example aspects of the data model(s) 742, such as generating (e.g., building, training) and applying the data model(s) 742, are described with reference to the figure descriptions herein.

The machine learning engine 741 and model(s) 742 may implement example aspects of the machine learning methods (e.g., learning tasks, learning functions that map local voltage to target reactive power setpoint etc.) and learned functions (e.g., learned equilibrium functions, etc.) described herein.

The training data 743 may include parameters and/or configurations of a generator 105 as described herein. The training data 743 may include reference data (e.g., previous configurations, previous performance data, previous reactive power setpoints, previous reactive power output, etc.) associated with one or more generators 105 and reference data (e.g., previous configurations, previous performance data, previous regulated voltage levels) associated with a distribution network 101.

The machine learning engine 741 may store, in the memory 740 (e.g., in a database included in the memory 740), historical information (e.g., reference data, measurement data, predictions, reactive power setpoints, voltage deviation values, power loss values, configurations, etc.) associated with the distribution network 101. Data within the database of the memory 740 may be updated, revised, edited, or deleted by the machine learning engine 741. In some aspects, the machine learning engine 741 may support continuous, periodic, and/or batch fetching of data (e.g., from a central controller, devices 705, etc.) and data aggregation.

The device 705 may render a presentation (e.g., visually, audibly, using haptic feedback, etc.) of an application 744 (e.g., a browser application 744-a, an application 744-b). The application 744-b may be an application associated with executing, controlling, and/or monitoring performance of a generator 105 as described herein. For example, the application 744-b may enable control of the device 705 and/or a generator 105 described herein.

In an example, the device 705 may render the presentation via the user interface 745. The user interface 745 may include, for example, a display (e.g., a touchscreen display), an audio output device (e.g., a speaker, a headphone connector), or any combination thereof. In some aspects, the applications 744 may be stored on the memory 740. In some cases, the applications 744 may include cloud-based applications or server-based applications (e.g., supported and/or hosted by the database 715 or the server 710). Settings of the user interface 745 may be partially or entirely customizable and may be managed by one or more users, by automatic processing, and/or by artificial intelligence.

In an example, any of the applications 744 (e.g., browser application 744-a, application 744-b) may be configured to receive data in an electronic format and present content of data via the user interface 745. For example, the applications 744 may receive data from a generator 105, another device 705, the server 710, and/or the database 715 via the communication network 720, and the device 705 may display the content via the user interface 745.

The database 715 may include a relational database, a centralized database, a distributed database, an operational database, a hierarchical database, a network database, an object-oriented database, a graph database, a NoSQL (non-relational) database, etc. In some aspects, the database 715 may store and provide access to, for example, any of the stored data described herein.

The server 710 may include a processor 750, a network interface 755, database interface instructions 760, and a memory 765. In some examples, components of the server 710 (e.g., processor 750, network interface 755, database interface 760, memory 765) may communicate over a system bus (e.g., control busses, address busses, data busses) included in the server 710. The processor 750, network interface 755, and memory 765 of the server 710 may include examples of aspects of the processor 730, network interface 735, and memory 740 of the device 705 described herein.

For example, the processor 750 may be configured to execute instruction sets stored in memory 765, upon which the processor 750 may enable or perform one or more functions of the server 710. In some examples, the server 710 may transmit or receive packets to one or more other devices (e.g., a device 705, the database 715, another server 710) via the communication network 720, using the network interface 755. Communications between components (e.g., processor 750, memory 765) of the server 710 and one or more other devices (e.g., a device 705, the database 715, etc.) connected to the communication network 720 may, for example, flow through the network interface 755.

In some examples, the database interface instructions 760 (also referred to herein as database interface 760), when executed by the processor 750, may enable the server 710 to send data to and receive data from the database 715. For example, the database interface instructions 760, when executed by the processor 750, may enable the server 710 to generate database queries, provide one or more interfaces for system administrators to define database queries, transmit database queries to one or more databases (e.g., database 715), receive responses to database queries, access data associated with the database queries, and format responses received from the databases for processing by other components of the server 710.

The memory 765 may be configured to store instruction sets, neural networks, and other data structures (e.g., depicted herein) in addition to temporarily storing data for the processor 750 to execute various types of routines or functions. For example, the memory 765 may be configured to store program instructions (instruction sets) that are executable by the processor 750 and provide functionality of a machine learning engine 766. One example of data that may be stored in memory 765 for use by components thereof is a data model(s) 767 (e.g., any data model described herein, a neural network model, etc.) and/or training data 768.

The data model(s) 767 and the training data 768 may include examples of aspects of the data model(s) 742 and the training data 743 described with reference to the device 705. The machine learning engine 766 may include examples of aspects of the machine learning engine 741 described with reference to the device 705. For example, the server 710 (e.g., the machine learning engine 766) may utilize one or more data models 767 for recognizing and processing information obtained from generators 105, devices 705, another server 710, and/or the database 715. In some aspects, the server 710 (e.g., the machine learning engine 766) may update one or more data models 767 based on learned information included in the training data 768.

In some aspects, components of the machine learning engine 766 may be provided in a separate machine learning engine in communication with the server 710.

The data model(s) 742 may include non-linear, self-learning, and dynamic data based models for voltage regulation in power distribution networks. Aspects of the present disclosure may support building and/or training a data model(s) 742 using machine learning techniques that are able to capture operational variations contained in the dataset without human intervention

In an example, the data model(s) 742 may be trained or may learn during a training phase about patterns in the dataset for voltage regulation in power distribution networks. In some aspects, the data model(s) 742 as trained may be deployed to determine parameters associated with regulating voltage (e.g., at the local level in association with a generator 105) in power distribution networks.

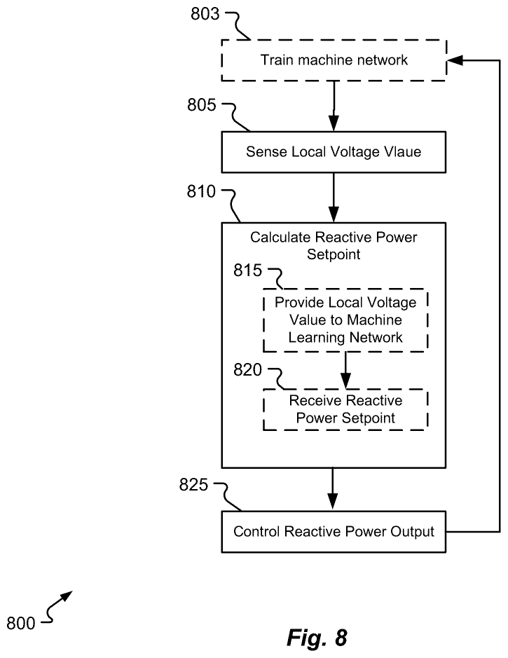

FIG. 8 illustrates an example of a process flow 800 that supports example aspects of the present disclosure described herein. In some examples, process flow 800 may be implemented by aspects of a system 700 (e.g., device 705, server 710, etc.) described with reference to FIG. 7. For example, process flow 800 may be implemented by a device 705 described with reference to FIG. 7. In an example, the device 705 includes a reactive power controller device associated with a distributed energy resource (DER) (e.g., a generator 105) electrically coupled to a power distribution network.

In the following description of the process flow 800, the operations may be performed in a different order than the order shown, or the operations may be performed in different orders or at different times. Certain operations may also be left out of the process flow 800, or one or more operations may be repeated, or other operations may be added to the process flow 800.

It is to be understood that while a device 705 is described as performing a number of the operations of process flow 800, any device (e.g., another device 705 in communication with the device 705 and/or the server 710, another server 710 in communication with the device 705 and/or the server 710, etc.) may perform the operations shown. In an example, the process flow 800 may be implemented by at least one processor (e.g., processor 730, processor 750, etc.) and at least one module operable by the at least one processor to perform one or more operations of the process flow 800. In another example, the process flow 800 may be implemented by sensing circuitry (e.g., sensing circuitry 731), processing circuitry (e.g., processor 730, processor 750, etc.), and control circuitry (e.g., control circuitry 732) described with reference to FIG. 7.

At 805, the process flow 800 may include sensing (e.g., by sensing circuitry 731) a local voltage value associated with the DER electrically coupled to the power distribution network.

At 810, the process flow 800 may include calculating (e.g., by processor 730 or processing circuitry included in the processor 730) a reactive power setpoint associated with the DER electrically coupled to the power distribution network, based at least in part on the local voltage value associated with the DER.

Aspects of the process flow 800 may be implemented in combination with a machine learning network (e.g., machine learning engine 741, model(s) 742, etc.). For example, calculating the reactive power setpoint may be based at least in part on a learned function associated with the DER, wherein the learned function comprises a mapping of a set of candidate local voltages associated with the DER to a set of candidate reactive power setpoints associated with DER.

In an example, at 815, the process flow 800 may include providing the local voltage value associated with the DER to a machine learning network (e.g., machine learning engine 741, model(s) 742, etc.). At 820, the process flow 800 may include receiving the reactive power setpoint associated with the DER in response to the machine learning network processing the local voltage value in association with a learned function.

At 825, the process flow 800 may include controlling (e.g., by control circuitry 732) a reactive power output of the DER in association with regulating voltage at the power distribution network, based at least in part on the reactive power setpoint.

In some aspects, the process flow 800 may include: iteratively calculating (not illustrated) the reactive power setpoint associated with the DER based at least in part on an increment; and iteratively setting (not illustrated) the reactive power output of the DER in response to one or more iterative calculations of the reactive power setpoint.

In some aspects, calculating the reactive power setpoint is based at least in part on one or more cost functions arbitrarily selected from a set of cost functions associated with the power distribution network.

In some aspects, calculating the reactive power setpoint, controlling the reactive power output, or both is independent of at least one second DER electrically coupled to the power distribution network.

Aspects of the systems and techniques described herein support training and/or retraining of the machine learning network. For example, at 803, the process flow 800 may include training the machine learning network. In an example, at 803, the process flow 800 may include training the machine learning network based at least in part on a set of reference local voltage values associated with the DER and a set of reference equilibrium points associated with the power distribution network, wherein training the machine learning network comprises generating the learned function. In another example, at 803, the process flow 800 may include training the machine learning network based at least in part on: one or more target reactive power setpoints associated with the DER and the power distribution network; and one or more reactive power injections associated with the power distribution network, wherein the one or more reactive power injections are non-controllable by the device.

The features described with reference to 803 of the process flow 800 may be implemented before or after any of the operations described herein with reference to process flow 800. For example, the features described with reference to 803 may be implemented prior to 805 or 810. In another example, the features described with reference to 803 may be implemented after 825 (e.g., further training the machine learning network based on further local voltage values sensed at 805, reactive power setpoints calculated at 810, reactive power output as controlled at 825, effects at a generator 105 (e.g., a DER), effects on the distribution network 101, etc.).

The exemplary systems and methods of this disclosure have been described in relation to examples of a distribution network 101 (e.g., power distribution network), a generator 105, a device 705, and a server 710. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a communication network, such as a LAN and/or the Internet, or within a dedicated system. Thus, it should be appreciated, that the components of the system can be combined into one or more devices, such as a server, communication device, or collocated on a particular node of a communication network, such as an analog and/or digital telecommunications network, a packet-switched network, or a circuit-switched network. It will be appreciated from the preceding description, and for reasons of computational efficiency, that the components of the system can be arranged at any location within a communication network of components without affecting the operation of the system.

While the process flows have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate example embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation or technique.

In one or more examples, the techniques described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

The foregoing disclosure includes various examples set forth merely as illustration. The disclosed examples are not intended to be limiting. Modifications incorporating the spirit and substance of the described examples may occur to persons skilled in the art. These and other examples are within the scope of this disclosure and the following claims.

What is claimed is:

1. A device comprising:
at least one processor; and
at least one module operable by the at least one processor to:
calculate a reactive power setpoint associated with a distributed energy resource (DER) electrically coupled to a power distribution network, based at least in part on a local voltage value associated with the DER; and
control a reactive power output of the DER in association with regulating voltage at the power distribution network, based at least in part on the reactive power setpoint.

2. The device of claim 1, wherein:
calculating the reactive power setpoint is based at least in part on a learned function associated with the DER, wherein the learned function comprises a mapping of a set of candidate local voltages associated with the DER to a set of candidate reactive power setpoints associated with DER.

3. The device of claim 1, wherein the at least one module operable by the at least one processor is to:
provide the local voltage value associated with the DER to a machine learning network; and
receive the reactive power setpoint associated with the DER in response to the machine learning network processing the local voltage value in association with a learned function.

4. The device of claim 3, wherein the at least one module operable by the at least one processor is to train the machine learning network based at least in part on a set of reference local voltage values associated with the DER and a set of reference equilibrium points associated with the power distribution network, wherein training the machine learning network comprises generating the learned function.

5. The device of claim 3, wherein the at least one module operable by the at least one processor is to train the machine learning network based at least in part on:
one or more target reactive power setpoints associated with the DER and the power distribution network; and
one or more reactive power injections associated with the power distribution network, wherein the one or more reactive power injections are non-controllable by the device.

6. The device of claim 1, wherein the at least one module operable by the at least one processor is to at least one of:
iteratively calculate the reactive power setpoint associated with the DER based at least in part on an increment; and
iteratively set the reactive power output of the DER in response to one or more iterative calculations of the reactive power setpoint.

7. The device of claim 1, wherein calculating the reactive power setpoint is based at least in part on one or more cost functions arbitrarily selected from a set of cost functions associated with the power distribution network.

8. The device of claim 1, wherein calculating the reactive power setpoint, controlling the reactive power output, or both is independent of at least one second DER electrically coupled to the power distribution network.

9. The device of claim 1, wherein the device comprises a reactive power controller device associated with the DER.

2. A method comprising:
calculating a reactive power setpoint associated with a distributed energy resource (DER) electrically coupled to a power distribution network, based at least in part on a local voltage value associated with the DER; and
controlling a reactive power output of the DER in association with regulating voltage at the power distribution network, based at least in part on the reactive power setpoint.

11. The method of claim 10, wherein:
calculating the reactive power setpoint is based at least in part on a learned function associated with the DER, wherein the learned function comprises a mapping of a set of candidate local voltages associated with the DER to a set of candidate reactive power setpoints associated with DER.

12. The method of claim 10, further comprising:
providing the local voltage value associated with the DER to a machine learning network; and
receiving the reactive power setpoint associated with the DER in response to the machine learning network processing the local voltage value in association with a learned function.

13. The method of claim 10, further comprising:
iteratively calculating the reactive power setpoint associated with the DER based at least in part on an increment; and
iteratively setting the reactive power output of the DER in response to one or more iterative calculations of the reactive power setpoint.

14. The method of claim 10, wherein calculating the reactive power setpoint is based at least in part on one or more cost functions arbitrarily selected from a set of cost functions associated with the power distribution network.

15. The method of claim 10, wherein calculating the reactive power setpoint, controlling the reactive power output, or both is independent of at least one second DER electrically coupled to the power distribution network.

3. A device associated with a distributed energy resource (DER) electrically coupled to a power distribution network, the device comprising:
sensing circuitry to sense a local voltage value associated with the DER;
processing circuitry to calculate a reactive power setpoint associated with a distributed energy resource (DER) electrically coupled to the power distribution network, based at least in part on the local voltage value associated with the DER; and
control circuitry to control a reactive power output of the DER in association with regulating voltage at the power distribution network, based at least in part on the reactive power setpoint.

17. The device of claim 16, wherein the processing circuitry is to:
calculate the reactive power setpoint based at least in part on a learned function associated with the DER, wherein the learned function comprises a mapping of a set of candidate local voltages associated with the DER to a set of candidate reactive power setpoints associated with DER.

18. The device of claim 16, further comprising one or more trained machine learning models, wherein:
the processing circuitry is to provide the local voltage value associated with the DER to a machine learning network; and
the machine learning network is to provide the reactive power setpoint associated with the DER in response to processing the local voltage value in association with a learned function.

19. The device of claim 16, wherein the processing circuitry is to:
iteratively calculate the reactive power setpoint associated with the DER based at least in part on an increment; and
iteratively set the reactive power output of the DER in response to one or more iterative calculations of the reactive power setpoint.

20. The device of claim 16, wherein the processing circuitry is to:
calculate the reactive power setpoint based at least in part on one or more cost functions arbitrarily selected from a set of cost functions associated with the power distribution network.
